(19) United States
(12) Patent Application Publication
(10) Pub. No.: US 2016/0248355 A1
(43) Pub. Date: Aug. 25, 2016

(54) MOTOR DRIVING DEVICE, METHOD FOR CONTROLING MOTOR, AND CALCULATION DEVICE FOR CALCULATING ANGLE INFORMATION OF MOTOR

(71) Applicant: ELECTRONICS AND TELECOMMUNICATIONS RESEARCH INSTITUTE, Daejeon (KR)

(72) Inventors: Jimin OH, Daejeon (KR); Minki KIM, Daejeon (KR); Jung Hee SUK, Daejeon (KR); Yil Suk YANG, Daejeon (KR); Sewan HEO, Daejeon (KR)

(73) Assignee: ELECTRONICS AND TELECOMMUNICATIONS RESEARCH INSTITUTE, Daejeon (KR)

(21) Appl. No.: 15/050,191

(22) Filed: Feb. 22, 2016

(30) Foreign Application Priority Data
Feb. 25, 2015 (KR) 10-2015-0026607

(51) Int. Cl. H02P 6/18; G01M 15/04

(52) U.S. Cl. CPC H02P 6/18; G01M 15/042

(57) ABSTRACT

Provided is a motor driving device. The motor driving device includes a motor controller configured to output a first phase signal, a second phase signal, and a third phase signal on the basis of an angle signal, a gate driver configured to output a first phase control signal, a second phase control signal, and a third phase control signal to an external motor on the basis of the first phase signal, the second phase signal, and the third phase signal, respectively, a current sensor configured to detect a first phase current signal, a second phase current signal, and a third phase current signal from the first phase control signal, the second phase control signal, and the third phase control signal, and a sensorless calculation circuit configured to calculate a current calculation signal using the first phase current signal, the second phase current signal, and the third phase current signal, to calculate a voltage calculation signal using the first phase signal and the second phase signal, and to calculate the angle signal using the current calculation signal and the voltage calculation signal.

### CROSS-REFERENCE TO RELATED APPLICATIONS

This U.S. non-provisional patent application claims priority under 35 U.S.C. §119 of Korean Patent Application No. 10-2015-0026607, filed on Feb. 25, 2015, the entire contents of which are hereby incorporated by reference.

### BACKGROUND

The present disclosure herein relates to a peripheral device of a motor, and particularly, to a motor driving device, a method for controlling a motor, and a calculation device for calculating angle information of a motor.

A motor is a device for converting electrical energy into mechanical energy using a force applied to a current in a magnetic field. Motors are divided into an AC motor and a DC motor depending on the type of input power. The AC motor supplies stator windings with a current to change a magnetic field, and thereby rotating a rotor. The DC motor supplies a rotor with a constant current to rotate the rotor. In this case, the DC motor uses a brush to allow the current to flow in a fixed direction regardless of the position of the rotor.

Recently, with the development of power electronic control technology, a Brushless Direct Current (BLDC) motor which does not use a brush by means of an electronic switching technique has been provided. The BLDC motor does not use a brush, and thus does not have limitations caused by wear of the brush and heat generation due to mechanical friction. However, in order to control the BLDC motor, an additional device for detecting the position of a rotor is required.

### SUMMARY

The present disclosure provides a motor driving device for detecting the position of a rotor in a sensorless BLDC motor, a method for controlling a motor, and a calculation device for calculating angle information of a motor.

A motor driving device according to an embodiment of the inventive concept includes a motor controller configured to output a first phase signal, a second phase signal, and a third phase signal on the basis of an angle signal, a gate driver configured to output a first phase control signal, a second phase control signal, and a third phase control signal to an external motor on the basis of the first phase signal, the second phase signal, and the third phase signal, respectively, a current sensor configured to detect a first phase current signal, a second phase current signal, and a third phase current signal from the first phase control signal, the second phase control signal, and the third phase control signal, and a sensorless calculation circuit configured to calculate a current calculation signal using the first phase current signal, the second phase current signal, and the third phase current signal, to calculate a voltage calculation signal using the first phase signal and the second phase signal, and to calculate the angle signal using the current calculation signal and the voltage calculation signal.

In an embodiment, the sensorless calculation circuit may be configured to calculate a first phase voltage calculation signal, a second phase voltage calculation signal, and a third phase voltage calculation signal on the basis of the first phase signal and the second phase signal.

In an embodiment, the sensorless calculation circuit may include a clock generator configured to generate a clock signal which transits periodically, a timer configured to measure one period of the first phase signal or the second phase signal using the clock signal, a counter configured to increase a count value using the clock signal when the first phase signal or the second phase signal has a high level, during the one period of the first phase signal or the second phase signal measured by the timer, and a duty calculator configured to calculate a duty of the first phase signal or the second phase signal using the count value.

In an embodiment, the sensorless calculation circuit may be configured to measure a first duty of the first phase signal, to measure a second duty of the second phase signal, and to calculate a third duty of the third phase signal using the first duty and the second duty.

In an embodiment, the sensorless calculation circuit may be configured to calculate a first phase sinusoidal signal, a second phase sinusoidal signal, and a third phase sinusoidal signal as the voltage calculation signal using the first duty, the second duty, and the third duty.

In an embodiment, the sensorless calculation circuit may be configured to calculate the third duty during a dead time of the first phase signal or the second phase signal.

In an embodiment, the sensorless calculation circuit may be configured to calculate a voltage utilization rate using the first duty, the second duty, and the third duty.

A method for controlling a sensorless BLDC motor according to an embodiment of the inventive concept includes receiving a first phase signal and a second phase signal which control currents supplied to the sensorless BLDC motor, measuring a first duty of the first phase signal and a second duty of the second phase signal, calculating a third duty of a third phase signal supplied to the sensorless BLDC motor on the basis of the first duty and the second duty, and calculating angle information of the sensorless BLDC motor on the basis of the first duty, the second duty, and the third duty.

In an embodiment, the measuring of the first duty of the first phase signal and the second duty of the second phase signal may include measuring one period of the first phase signal using a timer, counting sections in which the first phase signal has a high level, during the one period of the first phase signal measured by the timer, and calculating the first duty of the first phase signal according to the result of the counting of the first phase signal.

In an embodiment, the measuring of the first duty of the first phase signal and the second duty of the second phase signal may further include measuring one period of the second phase signal using the timer, counting sections in which the second phase signal has a high level, during the one period of the second phase signal measured by the timer, and calculating the second duty of the second phase signal according to the result of the counting of the second phase signal.

In an embodiment, the calculating of the angle information of the sensorless BLDC motor may include calculating a first phase sinusoidal signal, a second phase sinusoidal signal, and a third phase sinusoidal signal on the basis of the first duty, the second duty, and the third duty, respectively.

In an embodiment, the calculating of the angle information of the sensorless BLDC motor may further include calculating a voltage utilization rate of the first phase sinusoidal signal, the second phase sinusoidal signal, and the third phase sinusoidal signal on the basis of the first duty, the second duty, and the third duty, respectively.

In an embodiment, the calculating of the angle information of the sensorless BLDC motor may be performed during a dead time of the first phase signal or the second phase signal.

A calculation device for calculating angle information of a motor according to an embodiment of the inventive concept includes a voltage detector configured to receive a first phase signal and a second phase signal, and to calculate a first phase sinusoidal signal, a second phase sinusoidal signal, and a third phase sinusoidal signal on the basis of the first phase signal and the second phase signal, and an angle estimator configured to calculate angle information using the first phase sinusoidal signal, the second phase sinusoidal signal, and the third phase sinusoidal signal.

In an embodiment, the voltage detector may be configured to calculate a first duty of the first phase signal, to calculate a second duty of the second phase signal, to calculate a third duty on the basis of the first duty and the second duty, and to calculate the first phase sinusoidal signal, the second phase sinusoidal signal, and the third phase sinusoidal signal on the basis of the first duty, the second duty, and the third duty.

In an embodiment, the voltage detector may be configured to calculate the first duty by counting sections in which the first phase signal has a high level during one period of the first phase signal, and to calculate the second duty by counting sections in which the second phase signal has a high level during one period of the second phase signal.

In an embodiment, the calculation device further may include a current detector configured to receive a first phase current signal, a second phase current signal, and a third phase current signal, and to calculate a first phase current calculation signal, a second phase current calculation signal, and a third phase current calculation signal on the basis of the first phase current signal, the second phase current signal, and the third phase current signal.

In an embodiment, the angle estimator may be configured to calculate the angle information using the first phase sinusoidal signal, the second phase sinusoidal signal, the third phase sinusoidal signal, the first phase current calculation signal, the second phase current calculation signal, and the third phase current calculation signal.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a motor driving system according to an embodiment of the inventive concept;

FIG. 2 is a block diagram illustrating a voltage detector according to an embodiment of the inventive concept;

FIG. 3 is a flow diagram illustrating a method for controlling a motor according to an embodiment of the inventive concept;

FIG. 4 illustrates examples of a first phase signal and a second phase signal;

FIG. 5 illustrates an example in which a duty detector detects a first duty of a first phase signal and a second duty of a second phase signal;

FIG. 6 is a flow diagram illustrating a method for controlling a motor according to an embodiment of the inventive concept;

FIG. 7 illustrate an example in which levels of sinusoidal signals calculated by a sensorless calculation circuit change over time; and

FIG. 8 illustrate an example in which levels of sinusoidal signals calculated by a sensorless calculation circuit change over time.

### DETAILED DESCRIPTION

Hereinafter, preferred embodiments of the inventive concept will be described with reference to the accompanying drawings to fully explain the inventive concept in such a manner that it may easily be carried out by those skilled in the art.

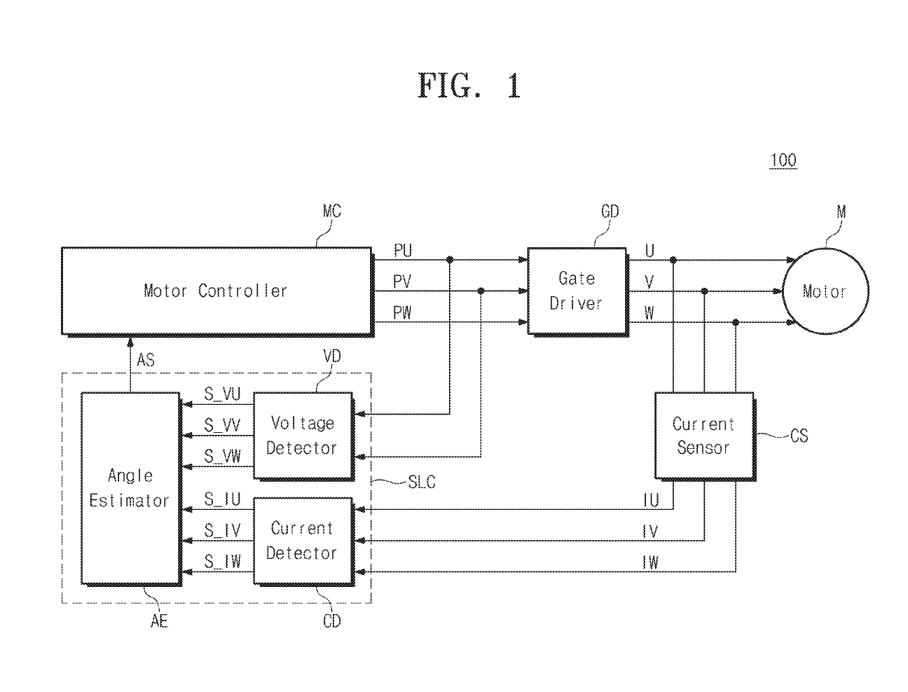

FIG. 1 is a block diagram illustrating a motor driving system 100 according to an embodiment of the inventive concept. Referring to FIG. 1, the motor driving system 100 includes a motor M, a motor controller MC, a gate driver GD, a current sensor CS, and a sensorless calculation circuit SLC.

The motor M is configured to operate in response to a first phase control signal U, a second phase control signal V, and a third phase control signal W which are output from the gate driver GD. For example, the motor M may include a sensorless Brushless Direct Current (BLDC) motor.

The motor controller MC is configured to output a first phase signal PU, a second phase signal PV, and a third phase signal PW in response to an angle signal AS. For example, the angle signal AS may include information on the position (e.g. rotation angle) of a rotor in the motor M. The motor controller MC may generate the first phase signal PU, the second phase signal PV, and the third phase signal PW for controlling the motor M with reference to the angle signal AS. The first phase signal PU, the second phase signal PV, and the third phase signal PW may be Pulse Width Modulated (PWM) signals.

The gate driver GD is configured to receive the first phase signal PU, the second phase signal PV, and the third phase signal PW from the motor controller MC. In response to the first phase signal PU, the second phase signal PV, and the third phase signal PW, the gate driver GD may output the first phase control signal U, the second phase control signal V, and the third phase control signal W. For example, the gate driver GD may provide a current source as at least one control signal of the first phase control signal U, the second phase control signal V, and the third phase control signal W, in response to the first phase signal PU, the second phase signal PV, and the third phase signal PW. Furthermore, the gate driver GD may provide a current sink as at least one control signal of the first phase control signal U, the second phase control signal V, and the third phase control signal W, in response to the first phase signal PU, the second phase signal PV, and the third phase signal PW. That is, the gate driver GD may control a current to flow in the motor M through the first phase control signal U, the second phase control signal V, and the third phase control signal W. The gate driver may include a power device, such as a metal oxide silicon field effect transistor (MOSFET) or an insulated gate bipolar mode transistor (IGBT), which is capable of supplying electric power.

The current sensor CS is configured to detect a first phase current signal IU, a second phase current signal IV, and a third phase current signal IW from the first phase control signal U, the second phase control signal V, and the third phase control signal W. For example, the current sensor CS may detect a magnitude and a direction of a current provided as the first phase control signal U, and output the detected result as the first phase current signal IU. The current sensor CS may detect a magnitude and a direction of a current provided as the second phase control signal V, and output the detected result as the second phase current signal IV. The current sensor CS may detect a magnitude and a direction of a current provided as the third phase control signal W, and output the detected result as the third phase current signal IW.

The sensorless calculation circuit SLC is configured to receive some of the phase signals from the motor controller MC, and to receive the phase current signals from the current sensor CS. Based on the received signals, the sensorless calculation circuit SLC may calculate the angle signal AS. The sensorless calculation circuit SLC includes a voltage detector VD, a current detector CD, and an angle estimator AE.

The voltage detector VD is configured to receive some of phase signals output from the motor controller MC. For example, the voltage detector VD may receive the first phase signal PU and the second phase signal PV from the motor controller MC. However, types of phase signals which the voltage detector VD receive from the motor controller MC are not limited. Based on the first phase signal PU and the second phase signal PV, the voltage detector VD may calculate a first phase voltage calculation signal S_VU, a second phase voltage calculation signal S_VV, and a third phase voltage calculation signal S_VW. For example, the first phase voltage calculation signal S_VU, the second phase voltage calculation signal S_VV, and the third phase voltage calculation signal S_VW may include information in which actual voltages applied to the motor M are estimated (or calculated). For example, the first phase voltage calculation signal S_VU, the second phase voltage calculation signal S_VV, and the third phase voltage calculation signal S_VW may respectively include information on a first phase sinusoidal signal sinPU, a second phase sinusoidal signal sinPV, and a third phase sinusoidal signal sinPW.

The current detector CD is configured to receive the first phase current signal IU, the second phase current signal IV, and the third phase current signal IW from the current sensor CS. Based on the first phase current signal IU, the second phase current signal IV, and the third phase current signal IW, the current detector CD is configured to calculate a first phase current calculation signal S_IU, a second phase current calculation signal S_IV, and a third phase current calculation signal S_IW. For example, the first phase current calculation signal S_IU, the second phase current calculation signal S_IV, and the third phase current calculation signal S_IW may include information in which actual currents applied to the motor M are estimated (or calculated).

The angle estimator AE is configured to receive the first phase voltage calculation signal S_VU, the second phase voltage calculation signal S_VV, and the third phase voltage calculation signal S_VW from the voltage detector VD. Furthermore, the angle estimator AE is configured to receive the first phase current calculation signal S_IU, the second phase current calculation signal S_IV, and the third phase current calculation signal S_IW from the current detector CD. Based on the first phase voltage calculation signal S_VU, the second phase voltage calculation signal S_VV, the third phase voltage calculation signal S_VW, the first phase current calculation signal S_IU, the second phase current calculation signal S_IV, and the third phase current calculation signal S_IW, the angle estimator AE is configured to calculate the angle signal AS. For example, the angle estimator AE may calculate (or estimate) the position (e.g. rotation angle) of the rotor in the motor M on the basis of information on voltages and currents actually applied to the motor M, and output the calculated result as the angle signal AS.

Exemplarily, the motor controller MC, the gate driver GD, the current sensor CS, and the sensorless calculation circuit SLC may constitute a motor driving device for driving the motor M.

As described with reference to FIG. 1, the sensorless calculation circuit according to an embodiment of the inventive concept is configured to calculate the angle signal AS, on the basis of the first phase signal PU and the second phase signal PV which are output from the motor controller MC, and the first phase current signal IU, the second phase current signal IV, and the third phase current signal IW which are output from the current sensor CS. The sensorless calculation circuit SLC does not use an internal signal of the motor controller MC, so that the sensorless calculation circuit SLC may be manufactured as a package or module which is separated from the motor controller MC.

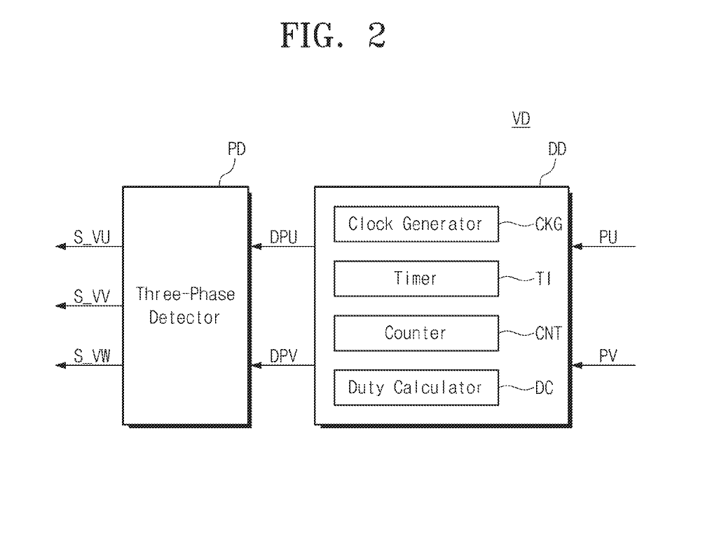

FIG. 2 is a block diagram illustrating a voltage detector VD according to an embodiment of the inventive concept. Referring to FIGS. 1 and 2, the voltage detector VD includes a duty detector DD and a three-phase detector PD.

The duty detector DD is configured to receive the first phase signal PU and the second phase signal PV, and to calculate a first duty DPU of the first phase signal PU and a second duty DPV of the second phase signal PV. For example, the first duty DPU may indicate the proportion of sections in which the first phase signal PU has a high level, during one period of the first phase signal PU, that is, one period in which pulse width modulation is performed. The second duty DPV may indicate the proportion of sections in which the second phase signal PV has a high level, during one period of the second phase signal PV, that is, one period in which pulse width modulation is performed. The duty detector DD includes a clock generator CKG, a timer TI, a counter CNT, and a duty calculator DC.

The clock generator CKG is configured to generate a clock signal which periodically transits between a high level and a low level. The frequency of the clock signal may be higher than that of the first phase signal PU or the second phase signal PV. For example, the frequency of the clock signal may be 1,000 times to 10,000 times higher than that of the first phase signal PU or the second phase signal PV.

The timer TI is configured to measure one period of the first phase signal PU or the second phase signal PV. For example, when the frequency of the first phase signal PU or the second phase signal PV is 20 KHz and the frequency of the clock signal is 20 MHz, one period of the first phase signal PU or the second phase signal PV may correspond to 1,000 periods of the clock signal. After the start of one period of the first phase signal PU or the second phase signal PV, the timer TI may use the clock signal to detect a time at which one period of the first phase signal PU or the second phase signal PV ends. At the time of the start or end of one period of the first phase signal PU or the second phase signal PV, the timer TI may be initialized.

The counter CNT is configured to increase a count value in response to the clock signal, when the first phase signal PU or the second phase signal PV has a high level during one period of the first phase signal PU or the second phase signal PV measured by the timer TI. The counter CNT may be initialized at the time of the start or end of one period of the first phase signal PU or the second phase signal PV. Exemplarily, the counter CNT may include a first phase counter which increases the counter number when the first phase signal PU has a high level, and a second phase counter which increases the counter number when the second phase signal PV has a high level.

The duty calculator DC is configured to calculate the first duty DPU of the first phase signal PU and the second duty DPV of the second phase signal PV on the basis of the count value of the counter CNT. For example, the duty calculator DC may calculate the first duty DPU by dividing a value counted by the counter CNT during one period of the first phase signal PU with a count value corresponding to one period of the first phase signal PU. The duty calculator DC may calculate the second duty DPV by dividing a value counted by the counter CNT during one period of the second phase signal PV with a count value corresponding to one period of the second phase signal PV.

The three-phase detector PD is configured to receive the first duty DPU and the second duty DPV from the duty detector DD. On the basis of the first duty DPU and the second duty DPV, the three-phase detector PD may calculate a third duty DPW of the third phase signal PW. Exemplarily, the sum of the first duty DPU, the second duty DPV, and the third duty DPW is 1.5. Thus, the three-phase detector PD may calculate the third duty DPW according to Equation 1.

DPW=1.5−DPU−DPV [Equation 1]

The three-phase detector PD may calculate a voltage utilization rate MI on the basis of the first duty DPU, the second duty DPV, and the third duty DPW. The voltage utilization rate MI may be calculated by Equation 2.

$$MI = \sqrt{\frac{{( 2 DPU - 1 )}^{2} + {( 2 DPV - 1 )}^{2} + {( 2 DPW - 1 )}^{2}}{( 3 / 2 )}} \qquad [ Equation 2 ]$$

The three-phase detector PD may calculate the first phase sinusoidal signal sinPU, the second phase sinusoidal signal sinPV, and the third phase sinusoidal signal sinPW, on the basis of the first duty DPU, the second duty DPV, the third duty DPW, and the voltage utilization rate MI. The first phase sinusoidal signal sinPU, the second phase sinusoidal signal sinPV, and the third phase sinusoidal signal sinPW may be calculated according to Equation 3.

sinPU=2ⁿ⁻¹+(2ⁿ⁻¹−1)(DPU−0.5)/0.5

sinPV=2ⁿ⁻¹+(2ⁿ⁻¹−1)(DPV−0.5)/0.5

sinPW=2ⁿ⁻¹+(2ⁿ⁻¹−1)(DPW−0.5)/0.5 [Equation 3]

In Equation 3, n refers to a calculation resolution of the three-phase detector PD. For example, n refers to the number of bits of a register which the three-phase detector PD uses to calculate each of the first phase voltage calculation signal S_VU, the second phase voltage calculation signal S_VV, and the third phase voltage calculation signal S_VW. Exemplarily, when the three-phase detector uses a 10-bits register, Equation 3 may be rewritten as Equation 4.

sinPU=512+511×(DPU−0.5)/0.5

sinPV=512+511×(DPV−0.5)/0.5

sinPW=512+511×(DPW−0.5)/0.5 [Equation 4]

Exemplarily, the maximum amplitude of each of the first phase sinusoidal signal sinPU, the second phase sinusoidal signal sinPV, and the third phase sinusoidal signal sinPW may be the voltage utilization rate MI. The three-phase detector PD may output information on levels of the first phase sinusoidal signal sinPU, the second phase sinusoidal signal sinPV, and the third phase sinusoidal signal sinPW, which are respectively calculated by the first duty DPU, the second duty DPV, and the third duty DPW, as the first phase voltage calculation signal S_VU, the second phase voltage calculation signal S_VV, and the third phase voltage calculation signal S_VW. For example, the three-phase detector PD may be configured to output information on levels in which the voltage utilization rate MI is applied (e.g. multiplied), or to further output information on the voltage utilization rate MI. Exemplarily, each of the first phase signal PU, the second phase signal PV, and the third phase signal PW may have a dead time between periods thereof. The duty detector DD may calculate the first duty DPU and the second duty DPV during one period. The three-phase detector PD may calculate the third duty DPW, the voltage utilization rate MI, and levels of the first phase sinusoidal signal sinPU, the second phase sinusoidal signal sinPV, and the third phase sinusoidal signal sinPW during the dead time. For example, when the dead time corresponds to 20 periods of the clock signal, the three-phase detector PD may complete the calculation during the elapse of 20 periods of the clock signal.

The first phase voltage calculation signal S_VU, the second phase voltage calculation signal S_VV, and the third phase voltage calculation signal S_VW, which are calculated by the three-phase detector PD, are delayed by one period of the first phase signal PU, the second phase signal PV, or the third phase signal PW. For example, when the first phase signal PU, the second phase signal PV, or the third phase signal PW has a frequency of 20 KHz, the first phase voltage calculation signal S_VU, the second phase voltage calculation signal S_VV, and the third phase voltage calculation signal S_VW are delayed by 50 μs. When the motor M is a 8-pole motor driven at 3,600 rpm, 50 μs corresponds to a rotation angle of 0.6°. The delay corresponding to a rotation angle of 0.6° does not cause any problem for driving the motor M, so that the position (e.g. rotation angle) of the rotor of the motor M is substantially accurately estimated.

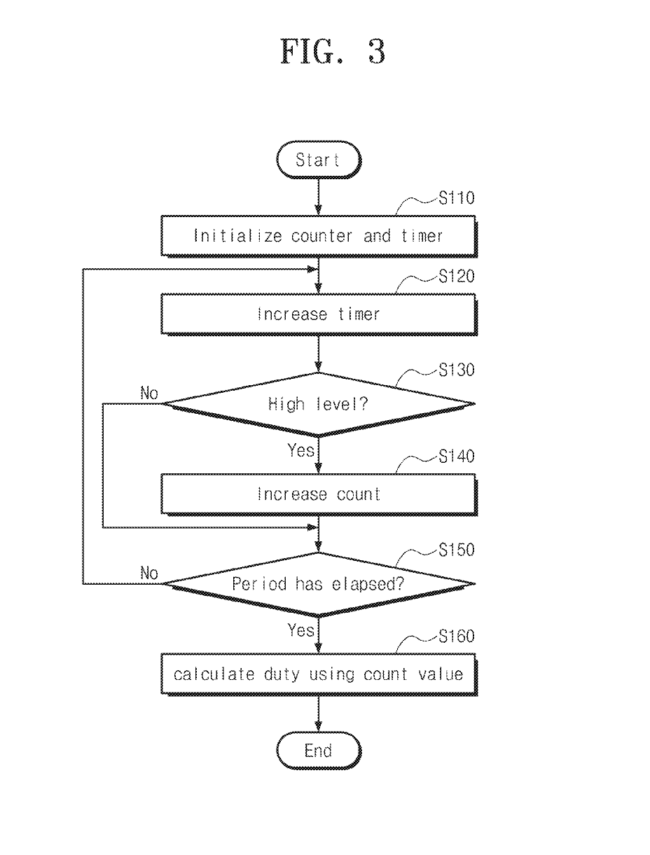

FIG. 3 is a flow diagram illustrating a method for controlling the motor M according to an embodiment of the inventive concept. Exemplarily, a method by which the duty detector DD of the sensorless calculation circuit SLC calculates the first duty DPU or the second duty DPV during one period of the first phase signal PU or the second phase signal PV is illustrated in FIG. 3.

Referring to FIGS. 1 to 3, in step S110, the counter CNT and the timer TI are initialized.

In step S120, when one period of the first phase signal PU or the second phase signal PV starts, the timer TI increases a time value according to a clock signal generated by the clock generator CKG.

In step S130, it is determined whether the first phase signal PU or the second phase signal PV has a high level. When the first phase signal PU or the second phase signal PV has a high level, the counter CNT increases a count number in step S140. Subsequently, step S150 is performed. When the first phase signal PU or the second phase signal PV has a low level, step S150 is performed without step S140. In step S150, it is determined whether one period of the first phase signal PU or the second phase signal PV elapsed. For example, it is determined whether the time value of the timer TI reaches a count number corresponding to one period of the first phase signal PU or the second phase signal PV. When the time value of the timer TI is less than the count value of one period, it is determined that one period does not elapse. When it is determined that one period does not elapse, step S120 is performed again. When the time value of the timer TI reaches the count value of one period, it is determined that one period has elapsed. When it is determined that one period has elapsed, step S160 is performed.

In step S160, the sensorless calculation circuit SLC calculates the first duty DPU or the second duty DPV.

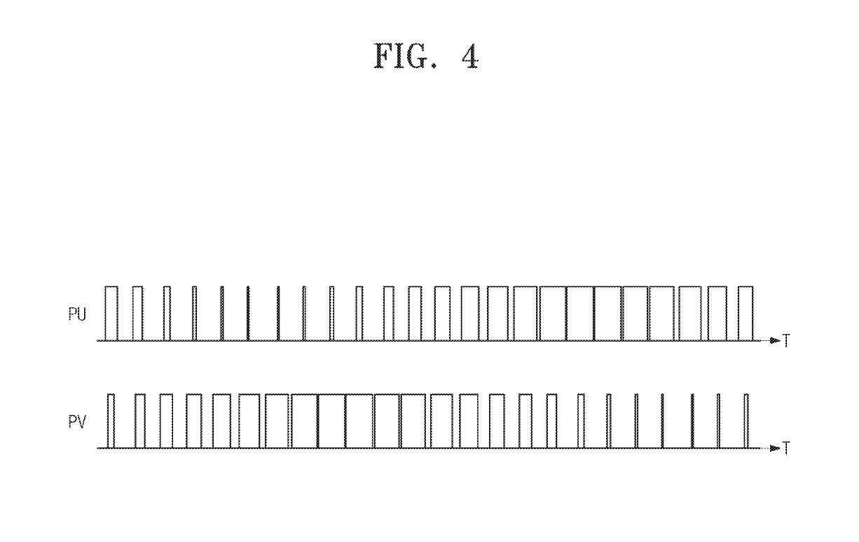

FIG. 4 illustrates examples of the first phase signal PU and the second phase signal PV. In FIG. 4, the horizontal axis represents a time and the vertical axis represents a voltage. Referring to FIG. 4, the first phase signal PU and the second phase signal PV may be pulse width modulated signals having pulse widths changing over time while transiting between a high level and a low level.

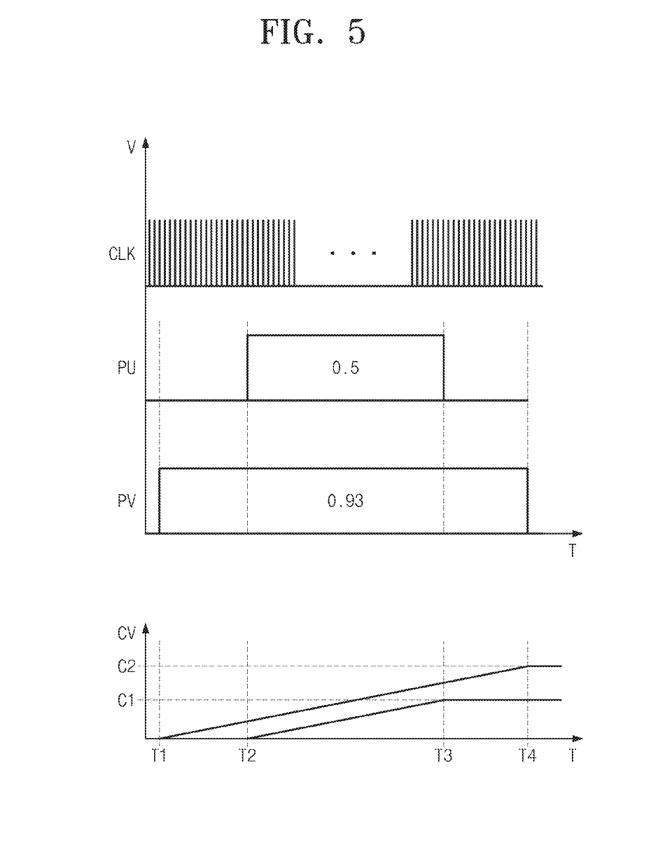

FIG. 5 illustrates an example in which the duty detector DD detects the first duty DPU of the first phase signal PU and the second duty DPV of the second phase signal PV. Exemplarily, an example, in which the first duty DPU and the second duty DPV are calculated during one period of the first phase signal PU and the second phase signal PV, is illustrated in FIG. 5. In FIG. 5, the horizontal axis represents a time T. The vertical axis corresponding to the clock signal CLK, the first phase signal PU, and the second phase signal PV represents a voltage. The vertical axis in the bottom graph represents a count value CV.

Referring to FIGS. 2 and 5, the second phase signal PV may have a high level from a first time T1. Thus, a second phase count value CPV corresponding to the second phase signal PV starts to increase from the first time T1.

The first phase signal PU has a high level from a second time T2. Thus, a first phase count value CPU corresponding to the first phase signal PU starts to increase from the second time T2.

The first phase signal PU has a low level from a third time T3. Thus, the first phase count value CPU is maintained without an increase after the third time T3.

The second phase signal PV has a low level from a fourth time T4. Thus, the second phase count value CPV is maintained without an increase after the fourth time T4.

The duty calculator DC may calculate the first duty DPU and the second duty DPV by respectively dividing the first phase count value CPU and the second phase count value CPV with the count value of one period. For example, the first duty DPU may be calculated to be ‘0.5’, and the second duty DPV may be calculated to be ‘0.93’.

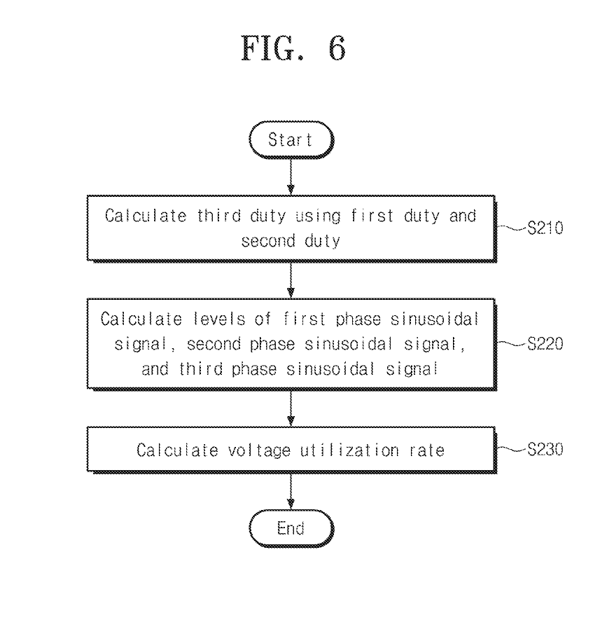

FIG. 6 is a flow diagram illustrating a method for controlling the motor M according to an embodiment of the inventive concept. Exemplarily, an example, in which the three-phase detector PD calculates the first phase voltage calculation signal S_VU, the second phase voltage calculation signal S_VV, and the third phase voltage calculation signal S_VW during a dead time, is illustrated in FIG.

6.

Referring to FIGS. 2 and 6, in step S210, the three-phase detector PD calculates the third duty DPW using the first duty DPU and the second duty DPV. For example, the three-phase detector PD may calculate the third duty DPW on the basis of Equation 1.

In step S220, levels of the first phase sinusoidal signal sinPU, the second phase sinusoidal signal sinPV, and the third phase sinusoidal signal sinPW may be calculated using the first to third duties DPU, DPV, and DPW. For example, the three-phase detector PD may calculate levels of the first phase sinusoidal signal sinPU, the second phase sinusoidal signal sinPV, and the third phase sinusoidal signal sinPW on the basis of Equation 3.

In step S230, the three-phase detector PD calculates the voltage utilization rate MI. For example, the three-phase detector PD may calculate the voltage utilization rate MI on the basis of Equation 2.

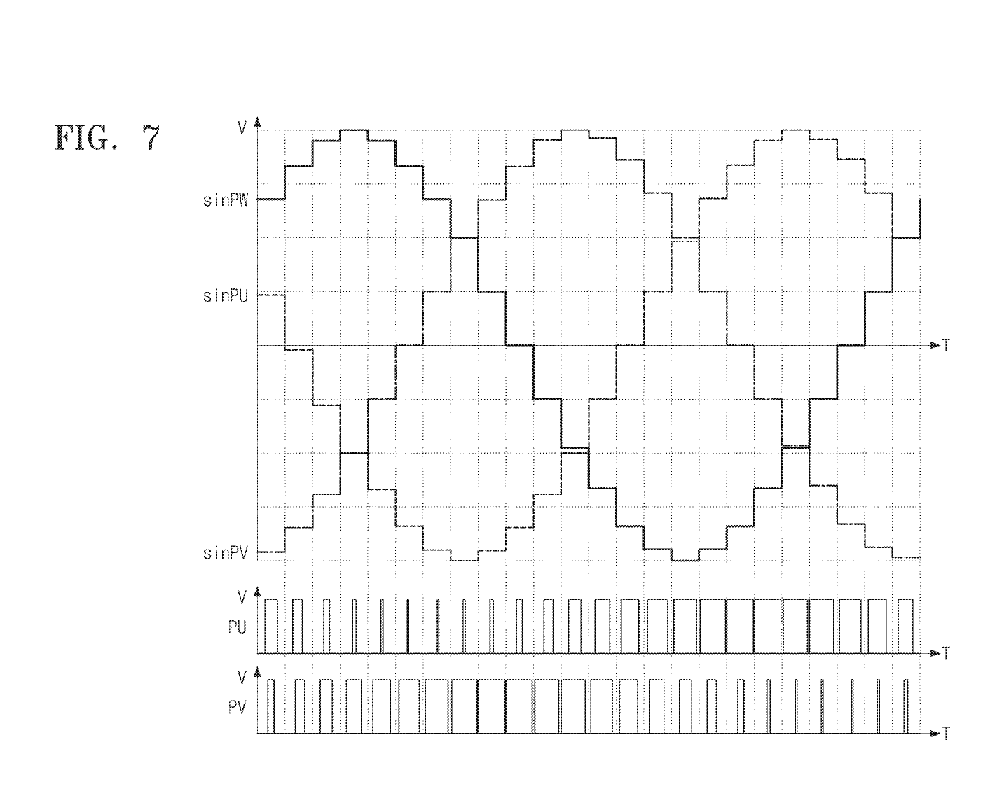

FIG. 7 illustrates an example in which levels of sinusoidal signals calculated by the sensorless calculation circuit SLC change over time. Exemplarily, an example, in which levels of three-phase sinusoidal signals change over time when the voltage utilization rate MI is ‘1’, is illustrated in FIG. 7. In FIG. 7, the horizontal axis represents a time, and the vertical axis represents a voltage.

Referring to FIG. 7, the sensorless calculation circuit SLC may calculate levels of the first phase sinusoidal signal sinPU, the second phase sinusoidal signal sinPV, and the third phase sinusoidal signal sinPW, for every period P of the first phase signal PU or the second phase signal PV. As the pulse width of the first phase signal PU or the second phase signal PV increases, the level of the first phase sinusoidal signal sinPU or the second phase sinusoidal signal sinPV increases. As the pulse width of the first phase signal PU or the second phase signal PV decreases, the level of the first phase sinusoidal signal sinPU or the second phase sinusoidal signal sinPV decreases.

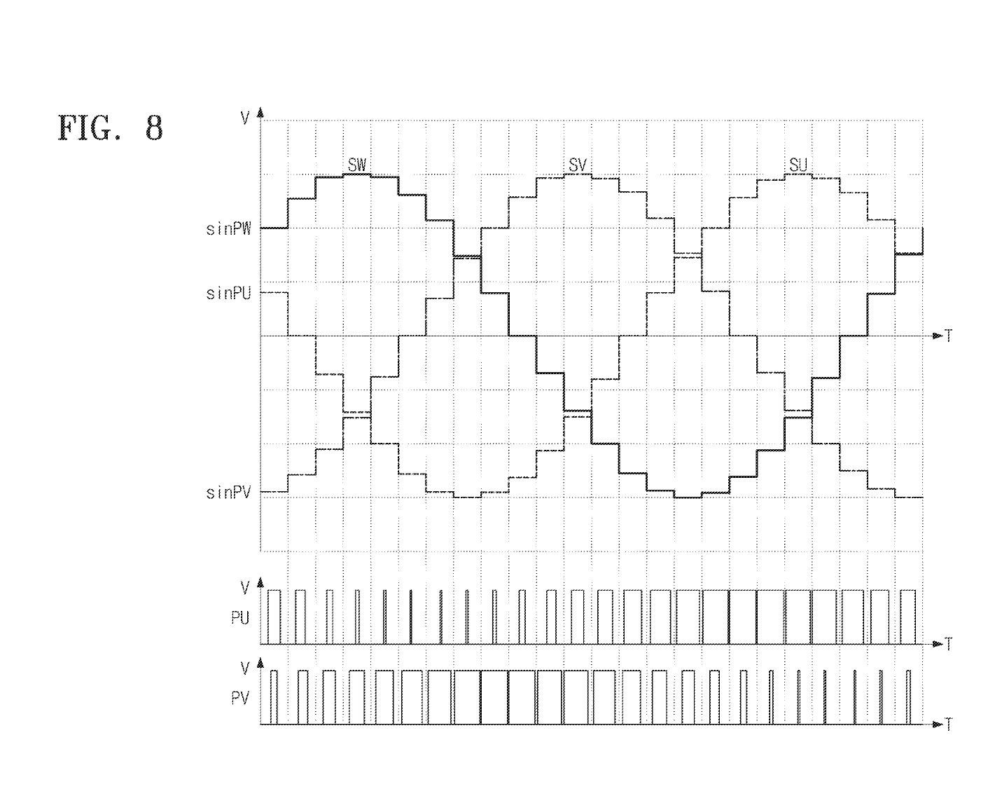

FIG. 8 illustrates an example in which levels of sinusoidal signals calculated by the sensorless calculation circuit SLC change over time. Exemplarily, an example, in which levels of three-phase sinusoidal signals change over time when the voltage utilization rate MI is ‘0.75’, is illustrated in FIG. 8. In FIG. 8, the horizontal axis represents a time, and the vertical axis represents a voltage.

Referring to FIG. 8, the sensorless calculation circuit SLC may calculate levels of the first phase sinusoidal signal sinPU, the second phase sinusoidal signal sinPV, and the third phase sinusoidal signal sinPW, for every period P of the first phase signal PU or the second phase signal PV. As the pulse width of the first phase signal PU or the second phase signal PV increases, the level of the first phase sinusoidal signal sinPU or the second phase sinusoidal signal sinPV increases. As the pulse width of the first phase signal PU or the second phase signal PV decreases, the level of the first phase sinusoidal signal sinPU or the second phase sinusoidal signal sinPV decreases.

Referring to FIGS. 7 and 8, in every period P of the first phase signal PU or the second phase signal PV, the amplitude width of the first phase sinusoidal signal sinPU, the second phase sinusoidal signal sinPV, and the third phase sinusoidal signal sinPW decreases as the voltage utilization rate MI decreases. The amplitude width of the first phase sinusoidal signal sinPU, the second phase sinusoidal signal sinPV, and the third phase sinusoidal signal sinPW increases as the voltage utilization rate MI increases.

As described with reference to FIGS. 7 and 8, the sensorless calculation circuit SLC may recover the first phase sinusoidal signal sinPU, the second phase sinusoidal signal sinPV, and the third phase sinusoidal signal sinPW, which are actually applied to the motor M, using the first phase signal PU and the second phase signal PV. Thus, the position (e.g. rotation angle) of the rotor of the motor M may be estimated, and accuracy of controlling the motor M is improved.

Particularly, the sensorless calculation circuit SLC may recover three-phase sinusoidal signals by measuring duties of three-phase signals using the counter CNT. Therefore, more accurate position estimation is achieved with a smaller size and a lower production cost, compared to devices that calculate voltage calculation signals from three-phase control signals U, V, and W using a digital signal processor (DSP) or calculate voltage calculation signals from three-phase control signals U, V, and W using a low-pass filter.

According to embodiments of the inventive concept, duties of a first phase signal and a second phase signal are calculated, and a first phase sinusoidal signal, a second phase sinusoidal signal, and a third phase sinusoidal signal, which are applied to a sensorless BLDC motor, are calculated according to the calculated duties. Therefore, the position of a rotor in the sensorless BLDC motor is accurately measured using a device having a smaller size and a lower production cost.

Although specific embodiments are described in the detailed description, various modifications can be made without departing from the scope and spirit of the invention. Therefore, the scope of the invention should not be defined by the above described embodiments, but should be determined by the accompanying claims as well as equivalents of the claims of the invention.

What is claimed is:

1. A motor driving device comprising:
a motor controller configured to output a first phase signal, a second phase signal, and a third phase signal on the basis of an angle signal;
a gate driver configured to output a first phase control signal, a second phase control signal, and a third phase control signal to an external motor on the basis of the first phase signal, the second phase signal, and the third phase signal, respectively;
a current sensor configured to detect a first phase current signal, a second phase current signal, and a third phase current signal from the first phase control signal, the second phase control signal, and the third phase control signal; and
a sensorless calculation circuit configured to calculate a current calculation signal using the first phase current signal, the second phase current signal, and the third phase current signal, to calculate a voltage calculation signal using the first phase signal and the second phase signal, and to calculate the angle signal using the current calculation signal and the voltage calculation signal.

2. The motor driving device of claim 1, wherein the sensorless calculation circuit is configured to calculate a first phase voltage calculation signal, a second phase voltage calculation signal, and a third phase voltage calculation signal on the basis of the first phase signal and the second phase signal.

3. The motor driving device of claim 1, wherein the sensorless calculation circuit comprises:
a clock generator configured to generate a clock signal which transits periodically;
a timer configured to measure one period of the first phase signal or the second phase signal using the clock signal;
a counter configured to increase a count value using the clock signal when the first phase signal or the second phase signal has a high level, during the one period of the first phase signal or the second phase signal measured by the timer; and
a duty calculator configured to calculate a duty of the first phase signal or the second phase signal using the count value.

4. The motor driving device of claim 1, wherein the sensorless calculation circuit is configured to measure a first duty of the first phase signal, to measure a second duty of the second phase signal, and to calculate a third duty of the third phase signal using the first duty and the second duty.

5. The motor driving device of claim 4, wherein the sensorless calculation circuit is configured to calculate a first phase sinusoidal signal, a second phase sinusoidal signal, and a third phase sinusoidal signal as the voltage calculation signal using the first duty, the second duty, and the third duty.

6. The motor driving device of claim 4, wherein the sensorless calculation circuit is configured to calculate the third duty during a dead time of the first phase signal or the second phase signal.

7. The motor driving device of claim 4, wherein the sensorless calculation circuit is configured to calculate a voltage utilization rate using the first duty, the second duty, and the third duty.

8. A method for controlling a sensorless BLDC motor, the method comprising:
receiving a first phase signal and a second phase signal which control currents supplied to the sensorless BLDC motor;
measuring a first duty of the first phase signal and a second duty of the second phase signal;
calculating a third duty of a third phase signal supplied to the sensorless BLDC motor on the basis of the first duty and the second duty; and
calculating angle information of the sensorless BLDC motor on the basis of the first duty, the second duty, and the third duty.

9. The method of claim 8, wherein the measuring of the first duty of the first phase signal and the second duty of the second phase signal comprises:
measuring one period of the first phase signal using a timer;
counting sections in which the first phase signal has a high level, during the one period of the first phase signal measured by the timer; and
calculating the first duty of the first phase signal according to the result of the counting of the first phase signal.

10. The method of claim 9, wherein the measuring of the first duty of the first phase signal and the second duty of the second phase signal further comprises:
measuring one period of the second phase signal using the timer;
counting sections in which the second phase signal has a high level, during the one period of the second phase signal measured by the timer; and
calculating the second duty of the second phase signal according to the result of the counting of the second phase signal.

11. The method of claim 8, wherein the calculating of the angle information of the sensorless BLDC motor comprises calculating a first phase sinusoidal signal, a second phase sinusoidal signal, and a third phase sinusoidal signal on the basis of the first duty, the second duty, and the third duty, respectively.

12. The method of claim 11, wherein the calculating of the angle information of the sensorless BLDC motor further comprises calculating a voltage utilization rate of the first phase sinusoidal signal, the second phase sinusoidal signal, and the third phase sinusoidal signal on the basis of the first duty, the second duty, and the third duty, respectively.

13. The method of claim 8, wherein the calculating of the angle information of the sensorless BLDC motor is performed during a dead time of the first phase signal or the second phase signal.

14. A calculation device for calculating angle information of a motor, the calculation device comprising:
a voltage detector configured to receive a first phase signal and a second phase signal, and to calculate a first phase sinusoidal signal, a second phase sinusoidal signal, and a third phase sinusoidal signal on the basis of the first phase signal and the second phase signal; and
an angle estimator configured to calculate angle information using the first phase sinusoidal signal, the second phase sinusoidal signal, and the third phase sinusoidal signal.

15. The calculation device of claim 14, wherein the voltage detector is configured to calculate a first duty of the first phase signal, to calculate a second duty of the second phase signal, to calculate a third duty on the basis of the first duty and the second duty, and to calculate the first phase sinusoidal signal, the second phase sinusoidal signal, and the third phase sinusoidal signal on the basis of the first duty, the second duty, and the third duty.

16. The calculation device of claim 15, wherein the voltage detector is configured
to calculate the first duty by counting sections in which the first phase signal has a high level during one period of the first phase signal, and
to calculate the second duty by counting sections in which the second phase signal has a high level during one period of the second phase signal.

17. The calculation device of claim 14, further comprising a current detector configured to receive a first phase current signal, a second phase current signal, and a third phase current signal, and to calculate a first phase current calculation signal, a second phase current calculation signal, and a third phase current calculation signal on the basis of the first phase current signal, the second phase current signal, and the third phase current signal.

18. The calculation device of claim 17, wherein the angle estimator is configured to calculate the angle information using the first phase sinusoidal signal, the second phase sinusoidal signal, the third phase sinusoidal signal, the first phase current calculation signal, the second phase current calculation signal, and the third phase current calculation signal.
